(19) United States
(12) Patent Application Publication
(10) Pub. No.: US 2025/0280303 A1
(43) Pub. Date: Sep. 4, 2025

(54) TECHNIQUES FOR RESOURCE ALLOCATION ON EQUIPMENT NODES

(71) Applicant: T-Mobile USA, Inc., Bellevue, WA (US)

(72) Inventors: Rongjie Ji, Lisle, IL (US); Rommel John G. Gammad, Elgin, IL (US); Mohammed Riazuddin Nizami, Bartlett, IL (US)

(21) Appl. No.: 18/592,438

(22) Filed: Feb. 29, 2024

(51) Int. Cl. H04W 24/02; H04W 72/04

(52) U.S. Cl. CPC H04W 24/02; H04W 72/04

(57) ABSTRACT

Techniques are described herein for mitigating network issues related to insufficient resources on hardware components (e.g., base stations). Such techniques may be performed by an Operations Support System (OSS) and may comprise receiving status information relating to an equipment node operating on a network. The techniques may further comprise determining, based on the status information, a predicted issue associated with the equipment node, identifying an allocation of resources determined to mitigate the predicted issue associated with the network, and generating, based on the identified allocation of resources, configuration data. The techniques may then comprise providing the configuration data to the equipment node to cause the equipment node to allocate one or more computing resources in accordance with eh identified allocation of resources.

### BACKGROUND

Cellular networks are frequently used to enable communication between various mobile devices. In a cellular network (such as the Global System for Mobile communication (GSM) and TETRA (TErrestrial Trunked RAdio)), a geographical region is divided into a number of cells, each of which is served by a base station (also referred to as a Base Transceiver Station (BTS)). Such cellular networks are typically made up of a number of base stations that are geographically distributed throughout the geographical region in a way that maximizes wireless transmission coverage for the cellular network. In such cellular networks, a cluster of geographically-proximate base stations may be managed locally by a computing device running an Operations Support System (OSS). Such a computing device may manage the cluster of base stations based on communications with a network management device. However, in cellular networks having thousands of base stations, detection and mitigation of issues associated with a single base station can be difficult.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 depicts an example environment in which equipment configurations can be updated to mitigate network issues in accordance with some embodiments.

FIG. 2 depicts a component diagram of an example system to be implemented in a network in order to reallocate resources in accordance with at least some embodiments.

FIG. 3 depicts a component diagram of an example equipment node that may be implemented in a network in order to reallocate resources in accordance with at least some embodiments.

FIG. 4 depicts a block diagram illustrating a network upon which a process for allocating resources to mitigate equipment node issues can be implemented in accordance with some embodiments.

FIG. 5 depicts a block diagram illustrating interactions between user devices and an equipment node in accordance with some embodiments.

FIG. 6 depicts

FIG. 7 depicts a flow diagram illustrating an exemplary process for mitigating equipment nodes issues/failures in accordance with at least some embodiments.

FIG. 8 shows an example computer architecture for a computing device 800 capable of executing program components for implementing the functionality described above.

### DETAILED DESCRIPTION

This disclosure describes techniques that may be performed to provide hardware configuration updates for a number of equipment nodes to a network management device in an optimal manner. The techniques may be performed between a number of network components, such as equipment nodes (e.g., base stations and other hardware components), a computing device operating an OSS that manage equipment nodes in a region, and a network management device.

In embodiments, a network management device may receive and aggregate information received from a number of hardware components operating on a network (e.g., a cellular network). The system can identify an issue related to insufficient resources (e.g., computing resources) based on data values (e.g., metrics) included in the information. Upon identifying a potential issue (e.g., an outage or connection error), the system may identify a configuration of resources determined to remedy or alleviate that potential issue. The system may then generate configuration data based on the identified configuration of resources that, when provided to an equipment node, causes the equipment node to reallocate computing resources in accordance with the identified configuration of resources.

Embodiments of the disclosure provide for a number of advantages over conventional systems. For example, when implemented, the system may allow for equipment nodes, such as base stations, to automatically mitigate predicted issues. Such mitigation may involve reallocating a set of available computing resources in order to meet a predicted increase in demand for certain functionality/network access. In some cases, an issue may be mitigated by preventing access to some functionality offered by the equipment node. In such cases, access to the functionality may be limited to user devices that meet predetermined criteria. Accordingly, the disclosed system allows for equipment within a network to mitigate (e.g., prevent or remedy) issues/outages that may occur in operation of the network while minimizing down time.

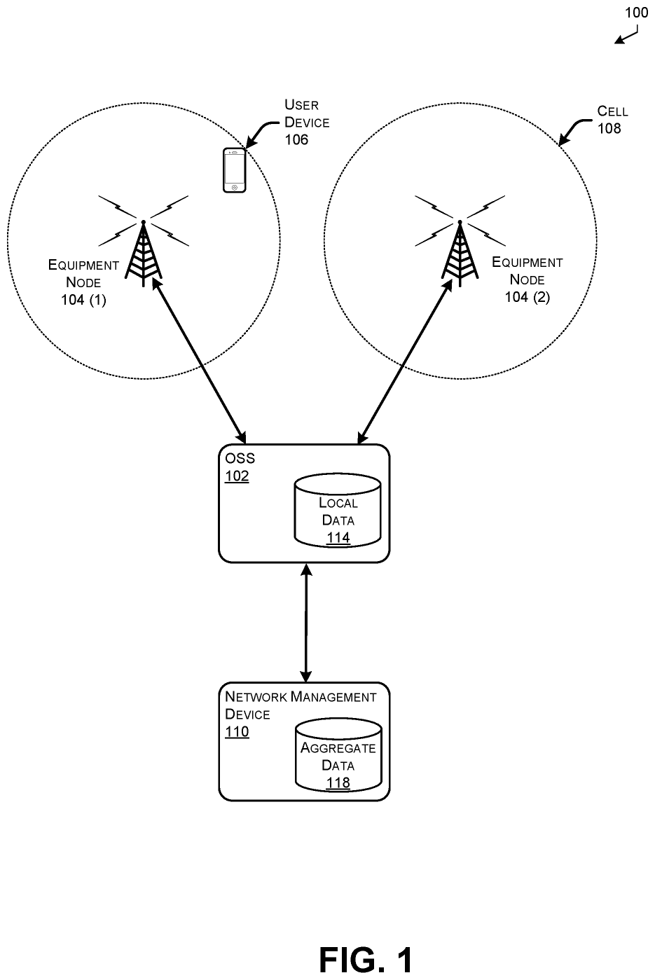

FIG. 1 depicts an example environment in which equipment configurations can be updated to mitigate network issues in accordance with some embodiments. In the system 100 depicted in FIG. 1, an Operations Support System (OSS) 102 may be in communication with a number of equipment nodes 104 (e.g., equipment nodes 104(1-2)). In some embodiments, the equipment nodes 104 may include one or more base stations that provide service (e.g., cellular data service) to a user device 106 within a cell 108 that defines a geographic area. The OSS 102 is in further communication with a network management device 110 configured to aggregate and manage information about a network (e.g., a cellular network).

An Operations Support System (OSS) 102 serves as a central point for administration, management, and provisioning of network elements located in a geographical region. An OSS 102 may be deployed to manage a number of equipment nodes 104 (e.g., base stations) within one of multiple geographic regions. Among other things, the OSS 102 administers the configurations/settings for the equipment nodes 104 in order to optimize network coverage in its respective geographic region. In embodiments, the OSS 102 may be configured to provide instructions to an equipment node 104 (e.g., a base station) to cause one or more components (either hardware or software components) to be reset/restarted.

In embodiments, the OSS 102 is configured to receive and/or manage a variety of status information received from each of the equipment nodes 104. For example, the OSS 102 may receive information about a transmission setting used by an equipment node 104 in communicating with various user devices. The OSS 102 may receive information about one or more user device 106 operating on the network that includes the equipment node 104. For example, such information may include details about operations/actions performed at the user device. In another example, such information may include information about one or more Key Performance Indicators (e.g., KPIs) related to network traffic generated by one or more user device 106 operating on the network.

The OSS 102 may be configured to store configuration parameters received from the equipment nodes as local data 114. In some embodiments, information is relayed to the OSS 102 for a number of equipment nodes 104(1-2). In these embodiments, the OSS 102 may provide desired instructions and/or configuration settings to the equipment nodes and may then cause the equipment nodes to carry out the instructions and/or implement those configuration settings.

The OSS 102 may be further configured to transmit change messages 116 that include an indication of changes in information (e.g., configuration parameters) associated with the equipment nodes 104 stored as local data 114 to the network management device 110. The network management device 110 may store such information received from a number of OSS devices as aggregate data. Such aggregate data may be used to optimize operation of a network (e.g., a cellular data network).

An equipment node 104 may include any suitable type of electronic equipment configured to perform one or more functions in accordance with instructions received from an OSS 102. As previously described, an equipment node 104 may be a base station that includes one or more transmission mechanisms (e.g., a radio transceiver) capable of enabling wireless communication with a number of user devices. Such base stations may be distributed over an area in a sufficiently dense manner such that user devices (e.g., mobile communication devices) in communication with the network can communicate with each other or with a terrestrial network. In some embodiments, the equipment node 104 may include one or more sensors configured to collect information about the equipment node 104 itself or an environment in which the equipment node 104 is situated. Additionally, the equipment node 104 may include one or more mechanical means of adjusting/configuring components of the equipment node. For example, the equipment node may include a radio antenna as well as a motorized mechanism for adjusting a position of the radio antenna. In this example, each time that the position of the radio antenna is updated, information about the new position of the radio antenna is relayed by the equipment node 104 to the OSS 102.

In embodiments, an equipment node 104 may include a number of components configured to perform functions. For example, the equipment node 104 may include various hardware modules that are each configured to perform a function. In another example, the equipment node 104 may include one or more software modules configured to manage operation of the various hardware modules.

An equipment node (e.g., a base station) that provides cellular service to various cellular devices located within wireless communication range may operate using multiple communication protocols. For example, a single equipment node 104 may provide both network service that uses a Long-Term Evolution (LTE) standard protocols as well as network service that uses a fifth generation (5G) standard protocols. In such embodiments, user devices operating on the network may default to a particular standard protocol. For example, user devices operating on the network that are able to use a 5G standard protocol may default to using that 5G standard protocol when it is available. It should be noted that while network coverage using a 5G standard protocol may not be available everywhere, such coverage may provide greater bandwidth, speed, and/or capacity as opposed to LTE where it is available.

A network system (e.g., a cellular network) in which the system 100 is implemented may provide network services to one or more user devices 106 via a base station (e.g., equipment node 104). The user device 106 may include any electronic device capable of interacting with a mobile network. In some non-limiting examples, the user device 106 may be a variety of devices including, for example: a mobile phone, a personal data assistant (PDA), or a mobile computer (e.g., a laptop, notebook, notepad, tablet, etc.) having mobile wireless data communication capability.

A network management device 110 may include any suitable computing device configured to manage operation of a network (e.g., a cellular network) as implemented herein. In some embodiments, the network management device 110 may include a Mobile Switching Center (MSC). Among other things, a MSC manages voice calls placed in and out of such a network. For example, the MSC may be configured to route calls to base stations for a particular cell 108 within which a user device 106 is located. As noted elsewhere, the network management device 110 may maintain aggregate data that includes information about a current status of each of the equipment nodes 104(1-2) in the network in which the system 100 is implemented.

The illustrative system 100 may be implemented within a mobile wireless network that incorporates, by way of example, CDMA2000 based mobile wireless network components (e.g., AAA service for performing user authentication and providing user profiles) and includes data services delivered via one or more data access protocols, such as EV-DO, EV-DV or the like. Other embodiments include a wireless access network complying with one or more of LTE, WCDMA, UMTS, GSM, GPRS, EDGE, Wi-Fi (i.e., IEEE 802.11x), Wi-MAX (i.e., IEEE 802.16), or similar telecommunication standards configured to deliver voice and data services to mobile wireless end user devices such as, a user device 106 depicted in FIG. 1 carrying out wireless communications via a base station (also referred to as a base transceiver station or cell site). Such a mobile wireless network system may include hundreds or thousands of such stations.

For clarity, a certain number of components are shown in FIG. 1. It is understood, however, that embodiments of the disclosure may include more than one of each component. In addition, some embodiments of the disclosure may include fewer than or greater than all of the components shown in FIG. 1. In addition, the components in FIG. 1 may communicate via any suitable communication medium (including the Internet), using any suitable communication protocol.

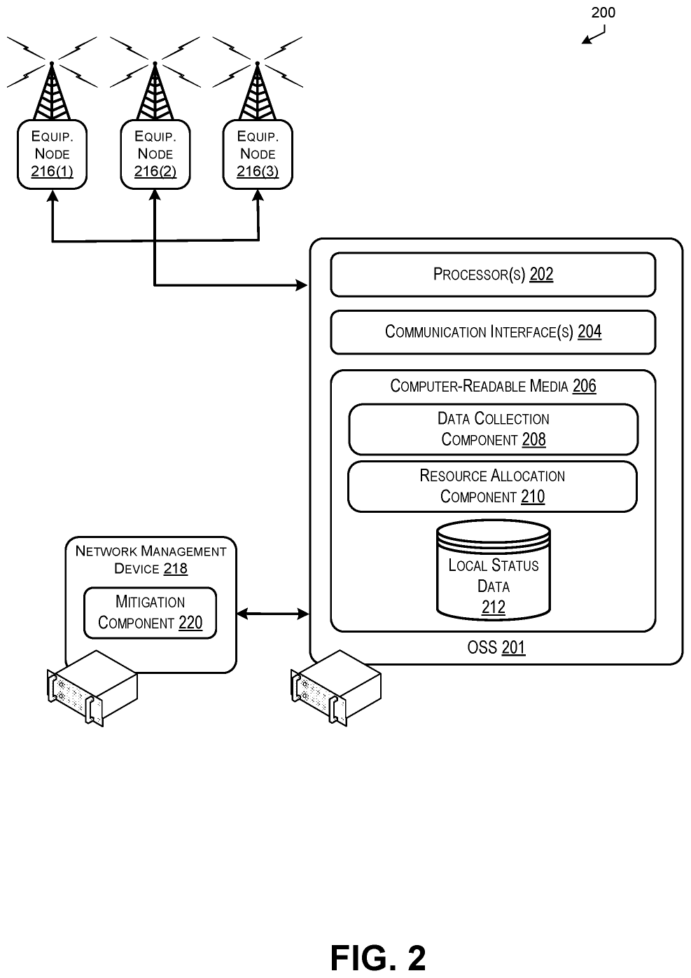

FIG. 2 depicts a component diagram of an example system to be implemented in a network in order to reallocate resources in accordance with at least some embodiments. As depicted in FIG. 2, an OSS 201 is in communication with a one or more equipment nodes 216. Additionally, the OSS 102 may be further in communication with a network management device 218.

The exemplary OSS 201 may be an example of the OSS 102 as described in relation to FIG. 1 above. It should be noted that the OSS (or any other described computing component) may include a single computing device (e.g., a server device) or a combination of computing devices. In some cases, the OSS may be implemented as a virtual system (e.g., via virtual machines implemented within a cloud computing environment).

As illustrated, the OSS 201 may include one or more hardware processors 202 configured to execute one or more stored instructions. Such processor(s) 202 may comprise one or more processing cores. Further, the OSS 201 may include one or more communication interfaces 204 configured to provide communications between the OSS 201 and other devices, such as the equipment nodes 216, network management device 218, or any other suitable electronic device.

The OSS 201 may also include computer-readable media 206 that stores various executable components (e.g., software-based components, firmware-based components, etc.). The computer-readable media 206 may store components to implement functionality described herein. While not illustrated, the computer-readable media 206 may store one or more operating systems utilized to control the operation of the one or more devices that comprise the OSS 201. According to one instance, the operating system comprises the LINUX operating system. According to another instance, the operating system(s) comprise the WINDOWS® SERVER operating system from MICROSOFT Corporation of Redmond, Washington. According to further embodiments, the operating system(s) can comprise the UNIX operating system or one of its variants. It should be appreciated that other operating systems can also be utilized.

The computer-readable media 206 may include portions, or components, that configure the OSS 201 to perform various operations described herein. For example, the computer-readable media 206 may include some combination of components configured to implement the described techniques. Particularly, the OSS 201 may include a component configured to perform data collection in relation to a number of equipment nodes of a network (e.g., data collection component 208) as well as a component for generating configuration settings to result in resource allocation on an equipment node (e.g., resource allocation component 210). Additionally, the computer-readable media 206 may further maintain one or more databases, such as a database of status information for equipment nodes included within a region managed by the OSS (e.g., local status data 212).

A data collection component 208 may be configured to, when executed by the processor(s) 202, receive status information related to one or more equipment nodes 216 and update a status of the respective equipment node within local status data 212. In some embodiments, status information for an equipment node 216 may be relayed to the OSS 201. In some cases, such status information may be obtained via one or more sensors installed upon (or in the vicinity of) the equipment node 216 and may include any suitable data related to the equipment node. The status information may include an indication of interactions between the equipment node and various user devices, such as outages, failures (e.g., connection failures), timeouts, etc. The information may include data about metrics obtained in relation to network traffic generated by the equipment node. In some cases, the status information may further indicate attributes of the equipment node itself, such as a current power transmission level, a transmission frequency (or band of frequencies), an antenna angle, a temperature, etc. In some cases, such information may be obtained from a device in communication with the equipment node, such as a router or other suitable electronic device. The received status information is then stored in relation to the respective equipment node 216.

A resource allocation component 210 may be configured to, when executed by the processor(s) 202, receive information about a resource that is unavailable/insufficient for current demand based on information received from an equipment node. For example, the OSS 201 may receive information from an equipment node about a number of access failures related to 5G network access attempts. The resource allocation component 210 may then determine that whether the number of access failures has exceeded an acceptable threshold value. In some cases, the threshold value may be an integer. In other cases, the threshold value may be a percentage, such as a percentage of the total number of user devices communicating with the equipment node, a percentage of the total number of access attempts made, etc. Based on determining that the number of access failures is greater than the acceptable threshold value, a determination may be made that additional 5G capacity (e.g., a resource) is needed.

In response to determining that a resource is needed by an equipment node, the resource allocation component 210 may be configured to identify a set of parameters to be updated in order to allocate additional resource to the equipment node. In some embodiments, this may involve identifying one or more underutilized resources on the equipment node and redirecting those resources to one that is needed. For example, if an equipment node has received a number of access failures for 5G over a period of time whereas access attempts for LTE are under capacity, then the total LTE capacity may be reduced on that equipment node in order to increase 5G capacity. In this example, the resource allocation component 210 may be configured to generate a set of configuration settings that, when implemented on an equipment node, cause that equipment node to reallocate LTE capacity to 5G capacity.

In some embodiments, the resource allocation component 210 may be configured to limit access to a resource. For example, the OSS 201 may receive information from an equipment node about a number of access failures related to 5G network access attempts. Upon determining that the number of access failures has exceeded an acceptable threshold value, the resource allocation component 210 may be configured to generate configuration settings that, when implemented on an equipment node, causes the equipment node to limit what user devices are able to access the resource. For example, when 5G access failures reach a threshold number, then an equipment node may be configured to only allow 5G access to user devices that have higher capacity requirements. In this example, a data buffer for a user device may be assessed to determine data transmission requirements for that user device. Access to the 5G network may be limited to only those user devices having a transmission requirement of a predetermined level. The equipment node may then allocate user devices that are not authorized to access the 5G network to the LTE network instead.

In embodiments, the network management device 218 may include one or more modules configured to detect and mitigate issues with an equipment node (e.g., mitigation component 220). In embodiments, information about equipment node issues, as well as status information relating to the equipment nodes leading up to such issues, may be used to train a machine learning model to correlate equipment node metrics/trends to equipment node issues. Additionally, the network management device 218 may be further trained to correlate a particular issue identified at each equipment node with configuration settings that can be implemented to resolve such issues. A machine learning model trained in such a manner may be used to identify configuration settings that can be generated by a resource allocation component 210 to be provided to an equipment node.

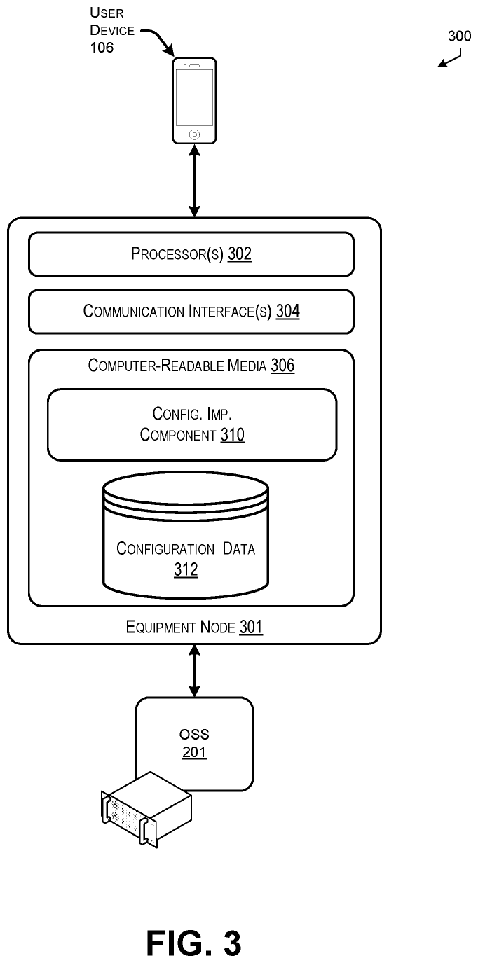

FIG. 3 depicts a component diagram of an example equipment node that may be implemented in a network in order to reallocate resources in accordance with at least some embodiments. As depicted in FIG. 3, an equipment node 301 may be in communication with a number of user devices 106 as well as an OSS 201.

As illustrated, the equipment node 301 may include one or more hardware processors 302 configured to execute one or more stored instructions. Such processor(s) 302 may comprise one or more processing cores. Further, the equipment node 301 may include one or more communication interfaces 304 configured to provide communications between the equipment node 301 and other devices, such as the user device 106, or any other suitable electronic device.

The equipment node 301 may also include computer-readable media 306 that stores various executable components (e.g., software-based components, firmware-based components, etc.). The computer-readable media 306 may store components to implement functionality described herein. While not illustrated, the computer-readable media 306 may store one or more operating systems utilized to control the operation of the one or more devices that comprise the equipment node 301. According to one instance, the operating system comprises the LINUX operating system. According to another instance, the operating system(s) comprise the WINDOWS® SERVER operating system from MICROSOFT Corporation of Redmond, Washington. According to further embodiments, the operating system(s) can comprise the UNIX operating system or one of its variants. It should be appreciated that other operating systems can also be utilized.

The computer-readable media 306 may include portions, or components, that configure the equipment node 301 to perform various operations described herein. For example, the computer-readable media 306 may include some combination of components configured to implement the described techniques. Particularly, the equipment node 301 may include a component configured to allocate resources (e.g., computing resources) within the equipment node in accordance with received configuration settings (e.g., configuration implementation component 310). In embodiments, the computer-readable media 306 may further include configuration data (e.g., configuration data 312) that includes information about resource configuration to be implemented on the equipment node 301. For example, the configuration data 312 may store configuration settings received from an OSS.

The configuration implementation component 310 may be configured to, when executed by a processor 302, implement a specified configuration. In embodiments, this may involve allocating computing resources in accordance with received configuration settings. For example, the equipment node may dedicate a first portion of its available computing resources to maintaining a 5G protocol network and a second portion of its available computing resources to maintaining an LTE protocol network. The amount of computing resources dedicated to each of the networks may correspond to the number of user devices and/or access attempts to be associated with the respective network.

It should be noted that a set of default configuration settings may be maintained by the equipment node that represent a default configuration for that equipment node. For example, the equipment node may maintain a set of default configuration settings that is implemented on the equipment node during normal operation. Upon receiving a set of configuration settings from an OSS, the configuration implementation component 310 may be configured to reallocate computing resources from that outlined in the default configuration to that outlined in the received configuration settings.

In some embodiments, the configuration implementation component 310 may be further configured to determine that a detected/predicted issue is no longer present and restore a previous configuration for the equipment node. For example, a determination may be made that a metric (e.g., number of access attempts per period of time) has returned to below a threshold value for a predetermined amount of time. In this example, upon making such a determination the configuration implementation component 310 may be configured to reallocate computing resources from that outlined in the received configuration settings back to that outlined in the default configuration.

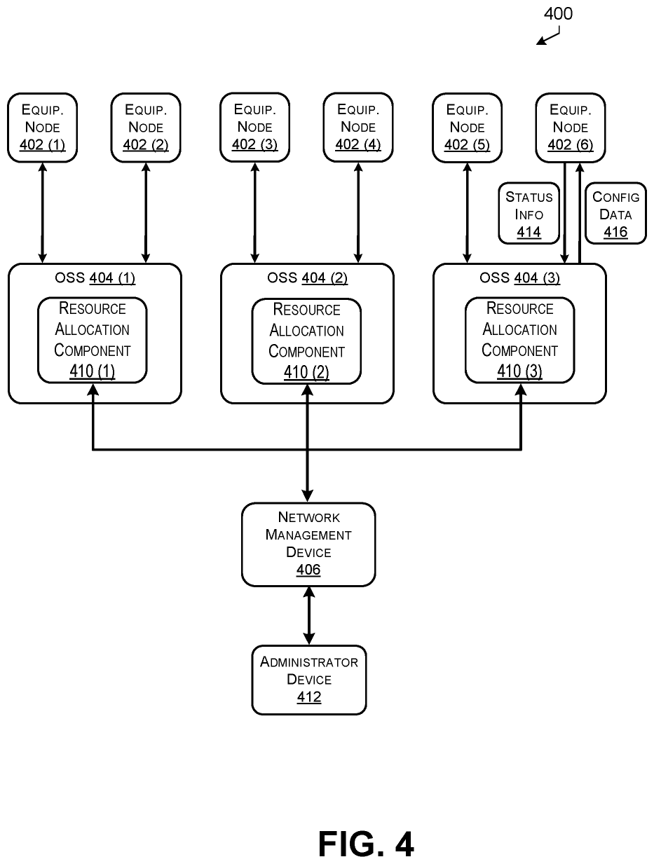

FIG. 4 depicts a block diagram illustrating a network upon which a process for allocating resources to mitigate equipment node issues can be implemented in accordance with some embodiments. In the exemplary network 400, a number of equipment nodes (e.g., base stations) 402(1-6) are configured to communicate with a number of computing devices each running an OSS 404(1-3). The number of computing devices operating OSS 404 may be further in communication with a network management device 406. In embodiments, the OSS 404 may maintain a resource allocation component 410(1-3) that maintains information about resource allocations to be made by an equipment node upon detecting respective conditions.

As noted elsewhere, an OSS 404 may include a resource allocation component 410 configured to associate one or more conditions with an issue (e.g., an alarm event) as well as with a resolution to that issue. Such a resolution may be representative of a set of configuration settings to be implemented on an equipment node to mitigate (e.g., prevent and/or fix) the issue. The resource allocation component 410 may be an example of the resource allocation component 210 as described in FIG. 2 above.

A resource allocation component 410 may be provisioned onto each of the OSS 404 by the network management device 406. In embodiments, network management device 406 may store information about equipment node issues/outages. Such information may include an indication of metrics attributed to the equipment leading up to the issue/outage. For example, a threshold number of connection request failures may be associated with a predicted network outage. In some embodiments, the network management device 406 may maintain information about resource allocations that can be implemented to prevent/fix such issues (e.g., resolution data). In the above example, allocating additional computing resources to a particular network until a number of connection requests have decreased may be associated with resolving a network outage. The network management device 406 may maintain an indication of particular allocation of computing resources to be implemented on the equipment node to prevent such an outage.

A resource allocation component that is provisioned onto each OSS 404 by the network management device 406 may take into account the mappings between known issues and known resolutions. In some embodiments, such a resource allocation component 410 may include, or otherwise use, a machine learning model that has been trained to correlate metrics received from an equipment node with various known issues.

In some embodiments, the network management device 406 may be in communication with an administrator device 412. Such an administrator device 412 may be operated by an administrative user, such as an authorized representative of an entity associated with the network. In some cases, when an issue is detected by an OSS 404, information about the issue/proposed resolution may be provided to the administrator device 412 for authorization/approval. In these cases, the proposed resolution may only be implemented by an OSS 404 upon receiving approval from an administrator device 412.

In an exemplary process implemented on the network 400, status information 414 related to an equipment node 402(6) is received at a respective OSS 404(3) associated with that equipment node. That status information 414, or some portion of it, is then analyzed to detect an issue that is currently, or predicted to be, associated with the equipment node 402(6).

In some cases, the status information 414 may include an indication of metrics related to the operation of the equipment node 402(6). For example, the status information 414 may include an indication of multiple connection request failures that have occurred within a period of time (e.g., last 10 minutes, etc.). Alternatively, the status information may include an indication that a number of connection requests are above a threshold connection request value within that period of time. In such cases, the OSS 404(3) may compare the received metrics against values associated with issues/outages in order to determine if the metrics meet conditions associated with a predicted issue. Upon determining that the conditions associated with an issue have been meet based on the received status information 414, the resource allocation component 410(3) may be configured to identify a resolution associated with the issue and to generate a set of configuration data based on hat resolution. In embodiments, the set of configuration data may include an indication of an allocation of computing resources to be implemented to resolve the issue.

In some cases, the OSS 404(3) may be configured to implement the proposed resolution automatically (e.g., without human interaction). This may involve generating computer-executable instructions that include the configuration data 416 based on the proposed resolution and providing those computer-executable instructions to the equipment node 402(6) to be executed.

In some cases, the OSS 404(3) may be configured to provide information about the identified alarm event and proposed resolution to an administrator device 412. In such cases, the administrator device 412 may be configured to present the information about the identified issue and proposed resolution to a user (e.g., an administrative user). The user may provide approval to implement the proposed resolution to the network management device 406, which may relay the approval to the OSS 404(3). Upon receiving such approval, the OSS 404(3) may generate computer-executable instructions that include the configuration data 418 based on the proposed resolution and provide those computer-executable instructions to the equipment node 402(6) to be executed.

Upon receiving configuration data 416, the equipment node 402(6) is configured to execute those instructions. In some cases, this may involve allocating computing resources in accordance with the received configuration data. For example, the computing resources dedicated to some functions may be repurposed to be dedicated to other functions instead. In this example, some instances of computing modules operating on the computing resources may be stopped or otherwise shut down and instances of computing modules associated with the new function may be spun up.

The OSS 404 may continue to receive status information 414 from the equipment node after the configuration data 416 has been implemented. In embodiments, the OSS 404 may be configured to determine that an issue has been resolved and return the equipment node 402 to a default configuration. For example, the OSS 404 may, upon receiving status information 414, determine that a number of connection requests has fallen below a threshold number of connection requests for a period of time (e.g., ten minutes). In this example, the OSS 404 may generate instructions to cause the equipment node 402 to return to its configuration prior to implementation of the configuration data 416.

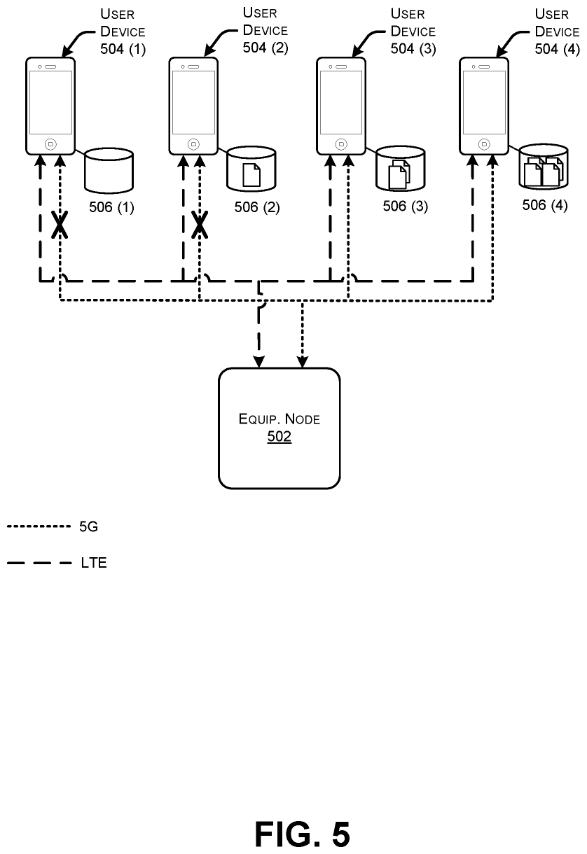

FIG. 5 depicts a block diagram illustrating interactions between user devices and an equipment node in accordance with some embodiments. As noted elsewhere, an equipment node 502 (e.g., a base station) may be in communication with multiple user devices 504(1-4).

In embodiments, an equipment node 502 may operate multiple different networks. For example, a single equipment node 502 may operate a first network that operates using an LTE standard protocol as well as a second network that operates using a 5G standard protocol. In this example, user devices that are capable of operating on the 5G network may typically default to operating on that network whereas user devices that are not capable of operating on the 5G network may operate on the LTE network.

As noted elsewhere, the equipment node 502 may receive configuration data from a OSS that indicates an allocation of computing resources to be implemented by that equipment node 502. As would be recognized by one skilled in the art, this may result in the capacity of some functionality provided by the equipment node 502 to be reduced, meaning that fewer user devices can be allowed to access that functionality.

In some embodiments, configuration data that is provided to an equipment node (e.g., by an OSS) may include an indication of settings to be implemented in regard to access to one or more networks. For example, upon the OSS making a determination that more user devices are attempting to access a network than is feasible (e.g., access requests are greater than a threshold number), the OSS may provide configuration data indicating one or more factors that should be used to limit access to the network. In such cases, only those user devices 504 determined to meet the requirements may be allowed to access that network (e.g., 5G network). User devices that do not meet the requirements may be delegated to a second network (e.g., LTE network).

In some cases, the user devices 504 may each relay information to the equipment node 502 that can be used to determine whether the individual user device should be granted access to functionality provided by the equipment node 502. In some cases, the equipment node 502 may grant or deny access for a user device 504 to functionality provided by the equipment node 502 based on factors determined from such information. Some factors that may be used by an equipment node may include information about metrics related to the operation of the user device, capabilities of the user device, a model/type of the user device, or any other suitable factor.

By way of illustration, in embodiments, an equipment node 502 may receive information from a user device 504 about a data buffer 506 (e.g., 1-4) associated with that user device 504. For example, the equipment node 502 may receive an indication of an amount of data to be relayed between the equipment node 502 and the user device 504. In such embodiments, the equipment node 502 may be configured to allow a user device to access the 5G network only if the amount of data in the data buffer 506 for that user device is greater than a threshold amount of data. In the illustrated example, user devices 504(3) and 504(4) may be granted access to the 5G network whereas user devices 504(1) and 504(2) may be denied access to the 5G network. Hence, the user devices 504(1) and 504(2) may be delegated to using the LTE network.

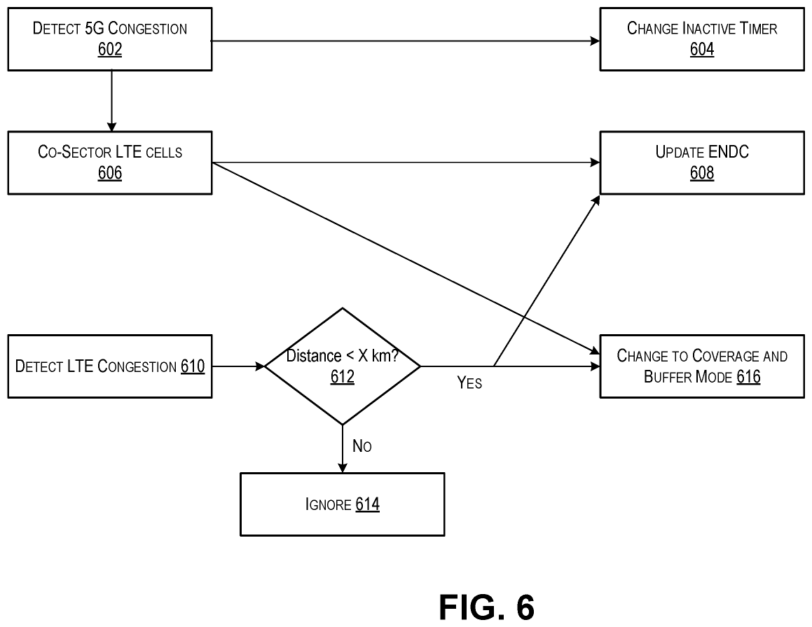

FIG. 6 depicts an example of issue detection and subsequent mitigation that may be implemented on a base station in accordance with some embodiments. In FIG. 6, the process 600 may be performed by an OSS that is in communication with multiple base stations, at least a portion of which are configured to operate on multiple networks. For example, at least some of the base stations in communication with the OSS may support access to both a LTE (e.g., 4G) network as well as a 5G network.

In 5G (New Radio or NR), NR-Counter Check is a procedure used to verify the integrity of the data transmission between the User Equipment (UE) and the network. This verification is essential for ensuring the reliability and security of the communication. During this procedure, the base station maintains counters that keep track of the number of transmitted and received packets or frames. These counters can be verified against information stored by the UE or OSS in order to verify the sequence and integrity of the data. Information about the counters can be provided by a base station to its OSS as status information.

The OSS may receive information about counters that relate to each of the networks supported by a base station. ENDC, or E-UTRAN New Radio-Dual Connectivity, is a Non-Standalone (NSA) feature that makes it possible for mobile devices to access both 5G and 4G LTE networks at the same time, which allows carriers to tap into the benefits of both network technologies simultaneously. In some cases, while a base station may be capable of supporting multiple networks, it may only provide access to a subset of those networks during normal operation. For example, a base station that provides support for both LTE and 5G may only provide access to the 5G network as a default. This is typically because LTE networks typically allow for UEs to operate on speeds of up to 100 Mbps while 5G networks allow for UEs to operate on speeds of up to 1 Gbps, which is significantly faster. Accordingly, to the base station may not provide access to the LTE network normally in order to provide optimal network speeds to the UEs that it supports. In the event that the 5G network becomes congested, it may be desirable to provide a combination of 5G and 4G LTE support, which provides additional bandwidth, and therefore, allows carriers to boost 5G availability, speed and reliability.

The OSS may receive status information from the base station that relates to one or more counters maintained by that base station. Upon receiving this information, the OSS may determine that the 5G network, as supported by that base station, is currently congested at 602. Such a determination may be made based on one or more conditions, such as if there are too many connection request failures or if the integrity of the data communications between the base station and its UEs begins to suffer (e.g., falls below an acceptable threshold).

In embodiments, upon detecting that the 5G network is congested at one or more base stations, the OSS may initially provide instructions to the respective base stations to cause them to change an inactive timer at 604. In 5G NR, the NR-RRC Inactive Timer is a timer used to manage the transition of a user equipment (UE) or device from an active state to an inactive state in the Radio Resource Control (RRC) protocol. The RRC protocol is responsible for controlling the connection and radio resources between the UE and the base station (gNB or gNodeB). The NR-RRC Inactive Timer plays a role in optimizing network resources and UE power consumption by causing more UEs to go inactive sooner, therefor reducing the amount of communications between the UE and the base station and freeing up bandwidth. In an example, the inactive timer may be changed from 10 seconds to 5 seconds.

At 606, the OSS may determine whether, and to what extent, the base station shares coverage with (e.g., co-sectors) with LTE cells. If the base station co-sectors with a number of LTE base stations, then the base station may be provided with instructions to move a number of UEs to be supported by those base stations instead. If there is insufficient LTE coverage in the area, then the OSS may provide instructions to the base station to cause it to update its ENDC at 608 in order to provide additional support for LTE coverage. Note that while 5G coverage is preferred, LTE coverage, with its lower data transmission capacity, can often support more UEs. Hence, enabling LTE coverage allows the base station to handle a greater number of UEs.

Additionally, the OSS may analyze status information for other base stations in the vicinity of the base station that is facing congestion. In some cases, the OSS may make a detection about LTE congestion at those base stations at 610. In embodiments, the OSS may be configured to check base stations within some predetermined threshold distance (e.g., X km) of the congested base station at 612, where X is some user-defined distance threshold. In embodiments, the OSS may ignore any base stations that are outside of that threshold distance for the purpose of this analysis at 614.

Based on the status of the LTE network in the area, the OSS may cause the base stations in the area to implement further changes. For example, the LTE base stations may be caused to update their ENDC as well. Additionally, one or more of the base stations may be caused to change from a coverage only mode to a coverage and buffer mode at 616. In such a mode, some UEs may be directed to operate on the LTE network and other UEs may be directed to operate on the 5G network based on an amount of data currently in the respective UEs data buffer. In such cases, UEs having more data in their data buffer (and UEs that don't have LTE coverage) may be provided access to the 5G network whereas the remaining UEs are delegated to LTE coverage.

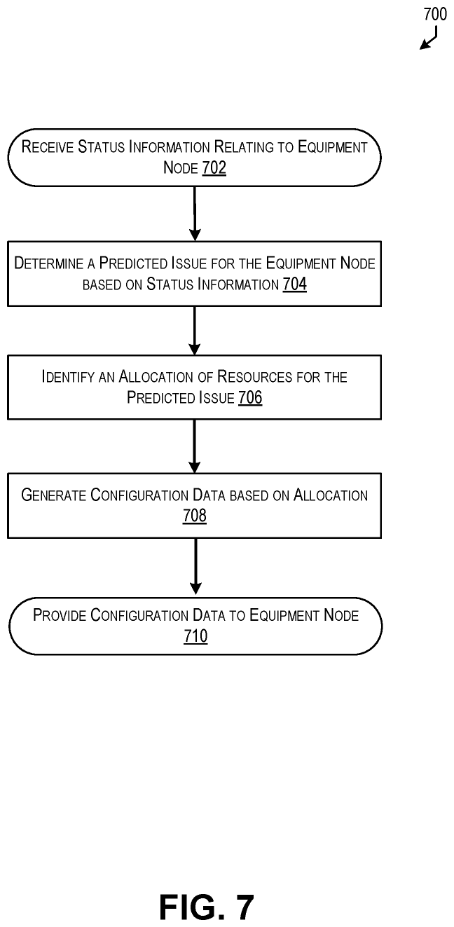

FIG. 7 depicts a flow diagram illustrating an exemplary process for mitigating equipment nodes issues/failures in accordance with at least some embodiments. The process 700 may be performed by an Operations Support System (OSS), such as the OSS 102 as described in relation to FIG. 1 above.

At 702, the process 700 may involve receiving status information relating to an equipment node that is operating on a network. In embodiments, the status information includes metric values associated with a performance of the equipment node. In some cases, the status information is received at periodic intervals (e.g., every 10 minutes).

At 704, the process 700 may involve determining a predicted issue associated with the equipment node. In some embodiments, the predicted issue may be determined based on an indication in the status information of a number of connection requests occurring over a period of time. More particularly, the predicted issue may be determined based on one or more metrics indicated in the status information exceeding a threshold metric value within a predetermined amount of time.

At 706, the process 700 may involve identifying an allocation of resources determined to mitigate the predicted issue associated with the network. In embodiments, the allocation of resources comprises additional computing resources dedicated to a function associated with the predicted issue.

At 708, the process 700 may involve generating, based on the identified allocation of resources, configuration data. In embodiments, the configuration data comprises an indication of the allocation of resources and instructions to implement the allocation of resources.

At 710, the process 700 may involve providing the configuration data to the equipment node. Upon receiving such configuration data, the equipment node is caused to allocate one or more computing resources in accordance with the identified allocation of resources. In embodiments, allocating the one or more computing resources byh the equipment node may involve stopping a first function on a set of computing resources and starting a second function on the set of computing resources.

In some embodiments, the process 700 may further involve providing a request to an administrator device operated by an administrative user of a network that includes the equipment node. In such embodiments, the configuration data may be provided to the equipment node upon receiving an authorization from the administrator device.

In some embodiments, the process 700 may further involve continuing to monitor status information received from the equipment node. In these embodiments, the OSS may determine, based on second status information, that a predicted issue has been mitigated. IN some embodiments, determining that the predicted issue is resolved may be based on one or more conditions being met for a period of time. In these embodiments, the one or more conditions being met may involve at least one data value determined from the status information exceeding a threshold data value.

For example, the OSS may determine that a number of access attempts associated with a network has been below a threshold value for a period of time. Upon making a determination that the predicted issue has been mitigated, the OSS may be configured to generate a second configuration data to be provided to the equipment node. This second configuration data, when implemented by an equipment node, may cause that equipment node to reallocate its computing resources in accordance with a default resource configuration.

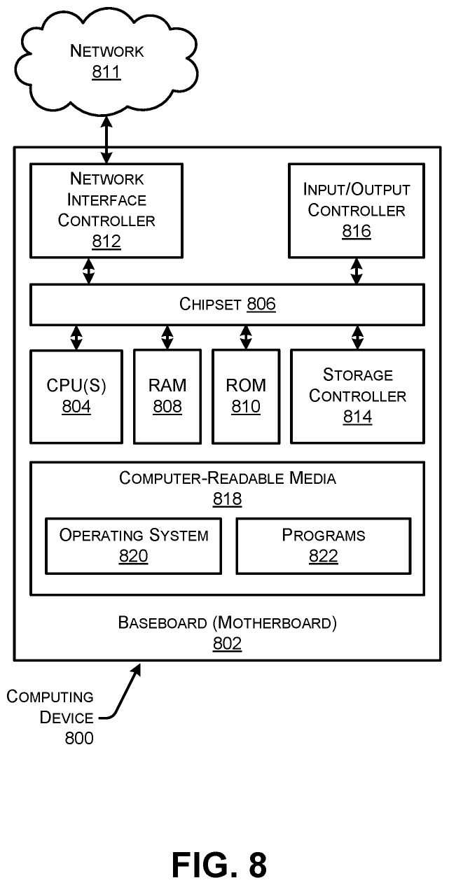

FIG. 8 shows an example computer architecture for a computing device 800 capable of executing program components for implementing the functionality described above. The computer architecture shown in FIG. 8 illustrates a conventional server computer, workstation, desktop computer, laptop, tablet, network appliance, e-reader, smartphone, or other computing device, and can be utilized to execute any of the software components presented herein. The computing device 800 may, in some examples, correspond to a physical server as described herein, and may comprise networked devices such as servers, switches, routers, hubs, bridges, gateways, modems, repeaters, access points, etc.

The computing device 800 includes a baseboard 802, or “motherboard,” which is a printed circuit board to which a multitude of components or devices can be connected by way of a system bus or other electrical communication paths. In one illustrative configuration, one or more central processing units (“CPUs”) 804 operate in conjunction with a chipset 806. The CPUs 804 can be standard programmable processors that perform arithmetic and logical operations necessary for the operation of the computing device 800.

The CPUs 804 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 806 provides an interface between the CPUs 804 and the remainder of the components and devices on the baseboard 702. The chipset 806 can provide an interface to a RAM 808, used as the main memory in the computing device 800. The chipset 806 can further provide an interface to a computer-readable storage medium such as a read-only memory (“ROM”) 810 or non-volatile RAM (“NVRAM”) for storing basic routines that help to startup the computing device 800 and to transfer information between the various components and devices. The ROM 810 or NVRAM can also store other software components necessary for the operation of the computing device 800 in accordance with the configurations described herein.

The computing device 800 can operate in a networked environment using logical connections to remote computing devices and computer systems through a network, such as the network 811. The chipset 806 can include functionality for providing network connectivity through a NIC 812, such as a gigabit Ethernet adapter. The NIC 812 is capable of connecting the computing device 800 to other computing devices over the network 811. It should be appreciated that multiple NICs 812 can be present in the computing device 800, connecting the computer to other types of networks and remote computer systems.

The computing device 800 can be connected to a storage device 818 that provides non-volatile storage for the computer. The storage device 818 can store an operating system 820, programs 822, and data, which have been described in greater detail herein. The storage device 818 can be connected to the computing device 800 through a storage controller 814 connected to the chipset 806. The storage device 818 can consist of one or more physical storage units. The storage controller 814 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computing device 800 can store data on the storage device 818 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 818 is characterized as primary or secondary storage, and the like.

For example, the computing device 800 can store information to the storage device 818 by issuing instructions through the storage controller 814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 800 can further read information from the storage device 818 by detecting the physical states or characteristics of one or more particular locations within the physical storage units.

In addition to the mass storage device 818 described above, the computing device 800 can have access to other computer-readable storage media to store and retrieve information, such as program modules, data structures, or other data. It should be appreciated by those skilled in the art that computer-readable storage media is any available media that provides for the non-transitory storage of data and that can be accessed by the computing device 800. In some examples, the operations performed by devices as described herein may be supported by one or more devices similar to computing device 800. Stated otherwise, some or all of the operations performed by an edge device, and/or any components included therein, may be performed by one or more computing device 800 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 818 can store an operating system 820 utilized to control the operation of the computing device 800. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 818 can store other system or application programs and data utilized by the computing device 800.

In one embodiment, the storage device 818 or other computer-readable storage media is encoded with computer-executable instructions which, when loaded into the computing device 800, transform the computer from a general-purpose computing system into a special-purpose computer capable of implementing the embodiments described herein. These computer-executable instructions transform the computing device 800 by specifying how the CPUs 804 transition between states, as described above. According to one embodiment, the computing device 800 has access to computer-readable storage media storing computer-executable instructions which, when executed by the computing device 800, perform the various processes described above with regard to the other figures. The computing device 800 can also include computer-readable storage media having instructions stored thereupon for performing any of the other computer-implemented operations described herein.

The computing device 800 can also include one or more input/output controllers 816 for receiving and processing input from a number of input devices, such as a keyboard, a mouse, a touchpad, a touch screen, an electronic stylus, or other type of input device. Similarly, an input/output controller 816 can provide output to a display, such as a computer monitor, a flat-panel display, a digital projector, a printer, or other type of output device. It will be appreciated that the computing device 800 might not include all of the components shown in FIG. 8, can include other components that are not explicitly shown in FIG. 8, or might utilize an architecture completely different than that shown in FIG. 8.

As described herein, the computing device 800 may include one or more hardware processors (processors), such as CPU 804, configured to execute one or more stored instructions. The processor(s) (e.g., CPU 804) may comprise one or more cores. Further, the computing device 800 may include one or more network interfaces configured to provide communications between the computing device 800 and other devices, such as the communications described herein as being performed by an edge device. The network interfaces may include devices configured to couple to personal area networks (PANs), wired and wireless local area networks (LANs), wired and wireless wide area networks (WANs), and so forth. More specifically, the network interfaces include the mechanical, electrical, and signaling circuitry for communicating data over physical links coupled to the network 811. The network interfaces may be configured to transmit and/or receive data using a variety of different communication protocols. Notably, a physical network interface may also be used to implement one or more virtual network interfaces, such as for virtual private network (VPN) access, known to those skilled in the art. In one example, the network interfaces may include devices compatible with Ethernet, Wi-Fi™, and so forth.

The programs 822 may comprise any type of programs or processes to perform the techniques described in this disclosure. The programs 822 may comprise any type of program that cause the computing device 800 to perform techniques for communicating with other devices using any type of protocol or standard usable for determining connectivity. These software processors and/or services may comprise a routing module and/or a Path Evaluation (PE) Module, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In general, routing module contains computer executable instructions executed by the processor to perform functions provided by one or more routing protocols. These functions may, on capable devices, be configured to manage a routing/forwarding table (a data structure) containing, e.g., data used to make routing forwarding decisions. In various cases, connectivity may be discovered and known, prior to computing routes to any destination in the network, e.g., link state routing such as Open Shortest Path First (OSPF), or Intermediate-System-to-Intermediate-System (ISIS), or Optimized Link State Routing (OLSR). For instance, paths may be computed using a shortest path first (SPF) or constrained shortest path first (CSPF) approach. Conversely, neighbors may first be discovered (i.e., a priori knowledge of network topology is not known) and, in response to a needed route to a destination, send a route request into the network to determine which neighboring node may be used to reach the desired destination. Example protocols that take this approach include Ad-hoc On-demand Distance Vector (AODV), Dynamic Source Routing (DSR), DYnamic MANET On-demand Routing (DYMO), etc. Notably, on devices not capable or configured to store routing entries, routing module may implement a process that consists solely of providing mechanisms necessary for source routing techniques. That is, for source routing, other devices in the network can tell the less capable devices exactly where to send the packets, and the less capable devices simply forward the packets as directed.

In various embodiments, as detailed further below, a PE module may also include computer executable instructions that, when executed by processor(s), cause computing device 800 to perform the techniques described herein. To do so, in some embodiments, a module may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, one or more module may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as normal or anomalous. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that path evaluation process can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for time series), random forest classification, or the like.

The performance of a machine learning model can be evaluated in a number of ways based on the number of true positives, false positives, true negatives, and/or false negatives of the model. For example, the false positives of the model may refer to the number of times the model incorrectly predicted an undesirable behavior of a path, such as its delay, packet loss, and/or jitter exceeding one or more thresholds. Conversely, the false negatives of the model may refer to the number of times the model incorrectly predicted acceptable path behavior. True negatives and positives may refer to the number of times the model correctly predicted whether the behavior of the path will be acceptable or unacceptable, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
receiving, at a computing device, status information relating to an equipment node operating on a network;
determining, by the computing device based on the status information, a predicted issue associated with the equipment node;
identifying, by the computing device, an allocation of resources determined to mitigate the predicted issue associated with the network;
generating, by the computing device based on the identified allocation of resources, configuration data; and
providing, by the computing device, the configuration data to the equipment node to cause the equipment node to allocate one or more computing resources in accordance with the identified allocation of resources.

2. The method of claim 1, further comprising:
receiving, at the computing device, second status information relating to the equipment node;
determining, by the computing device based on the second status information, that the predicted issue is resolved; and
providing, by the computing device to the equipment node, instructions to cause the equipment node to reallocate the one or more computing resources to a default configuration.

3. The method of claim 2, wherein determining that the predicted issue is resolved is based on one or more conditions being met for a period of time.

4. The method of claim 3, wherein the one or more conditions being met comprise at least one data value determined from the status information exceeding a threshold data value.

5. The method of claim 1, further comprising providing a request to an administrator device operated by an administrative user of a network that includes the equipment node.

6. The method of claim 5, wherein the configuration data is provided to the equipment node upon receiving an authorization from the administrator device.

7. The method of claim 1, wherein allocating the one or more computing resources comprises stopping a first function on a set of computing resources and starting a second function on the set of computing resources.

8. The method of claim 1, wherein the status information includes metric values associated with a performance of the equipment node.

9. The method of claim 1, wherein the predicted issue is determined based on an indication in the status information of a number of connection requests occurring over a period of time.

10. A computing device comprising:
one or more processors; and
one or more non-transitory computer-readable media storing computer-executable instructions that, when executed by the one or more processors, cause computing device to perform operations comprising:
receiving status information relating to an equipment node operating on a network;
determining, based on the status information, a predicted issue associated with the equipment node;
identifying an allocation of resources determined to mitigate the predicted issue associated with the network;
generating, based on the identified allocation of resources, configuration data; and
providing the configuration data to the equipment node to cause the equipment node to allocate one or more computing resources in accordance with the identified allocation of resources.

11. The computing device of claim 10, wherein the predicted issue is determined based on one or more metrics indicated in the status information exceeding a threshold metric value within a predetermined amount of time.

12. The computing device of claim 10, wherein the allocation of resources comprises additional computing resources dedicated to a function associated with the predicted issue.

13. The computing device of claim 10, wherein the configuration data comprises an indication of the allocation of resources and instructions to implement the allocation of resources.

14. The computing device of claim 10, wherein the status information includes at least one metric value associated with a performance of the equipment node.

15. The computing device of claim 14, wherein determining the predicted issue associated with the equipment node comprises determining that the at least one metric value exceeds a threshold value for a period of time.

16. The computing device of claim 10, wherein the status information is received at periodic intervals.

17. A system comprising:
an Operations Support System (OSS) device configured to:
receive status information relating to operation of at least one equipment node;
determine, based on the status information, a predicted issue associated with the at least one equipment node;
identify an allocation of resources associated with the predicted issue;
generate instructions associated with the allocation of resources; and
provide the instructions to the at least one equipment node; and
the at least one equipment node configured to allocate one or more computing resources in accordance with the received instructions.

18. The system of claim 17, wherein the at least one equipment node comprises a base station.

19. The system of claim 18, wherein the base station services multiple user devices operating on a cellular network.

20. The system of claim 17, wherein the at least one equipment node is further configured to implement a previous allocation of the one or more computing resources upon a determination that the predicted issue has been mitigated.
